(19) United States
(12) Patent Application Publication
(10) Pub. No.: US 2012/0132686 A1
(43) Pub. Date: May 31, 2012

(54) INSIDE DRAWER MOUNTED FOOD WRAP CUTTER

(76) Inventors: Henry Mathew Elash, Surrey (CA); Sandra Corinne Elash, Surrey (CA)

(21) Appl. No.: 13/380,756

(22) PCT Filed: May 14, 2010
(86) PCT No.: PCT/CA10/00738

§ 371 Date: Dec. 23, 2011

Related U.S. Application Data
(60) Provisional application No. 61/213,227, filed on May 19, 2009.

(51) Int. Cl. B65H 35/06; A47B 77/04; B26F 3/00

(52) U.S. Cl. 225/1; 225/91; 225/39

(57) ABSTRACT

Devices and methods for cutting sheet material using at least one wall of a general purpose storage container. The devices having a mounting portion which is removably attachable to the wall of the general purpose storage container and a cutting portion for severing selected pieces of sheet material stored in the general purpose storage container.

### CROSS REFERENCE TO RELATED APPLICATIONS

This application claims the benefit of U.S. Provisional Application No. 61/213,227 filed May 19, 2009.

### BACKGROUND OF THE INVENTION

Conventional devices for cutting sheet material and especially food wrap typically involve the permanent attachment of a cutting blade to a specialized container, see for example U.S. Pat. No. 5,984,158 to Frank which relates to a cutting blade for an aluminum foil dispenser. In such conventional devices, the cutting blade is typically attached next to, or over, a wall of the specialized container that is narrow, typically less than ⅛ inch (0.3 centimeters), see for example U.S. Pat. No. 6,491,198 to Frank, U.S. Pat. No. 2,771,186 to Burbank, U.S. Pat. No. 3,567,087 to Schramm and U.S. Pat. No. 5,947,360 to Frank.

However, none of these devices provide for the attachment of the device to a general purpose container such as a drawer which have wider walls, typically ¼ inch (0.6 centimeters) or more, and which can be used to store other objects. Further, these devices are generally designed for permanent attachment to the specialized container.

### BRIEF SUMMARY OF THE INVENTION

One aspect of the present invention is to provide a device for cutting food wrap or other sheet material which can be removably mounted on or in a general purpose storage container such as a drawer. In one embodiment, this device is concealed when the drawer is in a closed position.

Another aspect of the present invention is to provide a device for cutting sheet material having: (1) a mounting portion for attachment to a wall of a general purpose storage container, the general purpose storage container having a holder for the sheet material, and storage space for objects other than the sheet material; and (2) a cutting portion attached to the mounting portion along a first side and having a cutting edge along a second side. In addition, the general purpose storage container can be a drawer and the drawer can be mounted in a cabinet. Also, the drawer can include means for moving the drawer from a first position where at least a portion of the cutting portion is accessible from outside the cabinet and a second position where the cutting portion is not accessible from outside the cabinet.

Further aspects of the present invention include: (1) the holder being a bottom surface of the general purpose storage container; (2) the mounting portion being removably attached to the wall; and/or (3) the mounting portion being a channel having a base and two arms, the channel being placed over a top of the wall such that the base of the channel is adjacent to the top of the wall and the arms of the channel are adjacent to the inside surface and outside surface of the wall respectively. Also, the base and arms of the channel can be generally flat.

Yet another aspect of the present invention provides: (1) that the second side of the cutting portion is positioned parallel to, and proximate to, the plane defined by the outside surface of the wall; and/or (2) that the cutting edge includes a series of teeth for cutting the sheet material. Also, the corner between a ridge of a tooth and the inside wall of the tooth can be rounded and/or a corner between a ridge of a tooth and the outside wall of the tooth can form an angle of about 90 degrees.

A further aspect of the present invention provides a system for cutting sheet material having: (1) a drawer having general storage space for holding a sheet material supply and at least one other object; and (2) a cutter having a mounting portion and a cutting portion, the mounting portion providing means for attaching the cutter to a wall of the drawer.

Another aspect of the present invention is to provide a method for cutting sheet material in which a user: (1) opens a drawer having a cutter on a wall of the drawer; (2) pulls sheet material from a holder in the drawer such that the sheet material extends across a cutting edge of the cutter; (3) applies stress to the sheet material, such that a portion of the sheet material presses against the cutting edge of the cutter; (4) severs a portion of the sheet material from the sheet material along the portion of the sheet material pressing against the cutting edge; (5) removes the severed portion for use; and/or (6) closes the drawer. In addition, the method can include: (1) attaching a mounting portion of the cutter to the wall; and/or (2) detaching a mounting portion of the cutter from the wall to remove the cutter.

### BRIEF DESCRIPTION OF THE DRAWINGS

FIG. 1 is a perspective view of a sheet material cutter device illustrating one embodiment of the present invention;

FIG. 2 is a view from above of a sheet material cutter device and a general purpose container illustrating one embodiment of the present invention;

FIG. 3 is a perspective view of the use of a sheet material cutter device and a general purpose container illustrating one embodiment of the present invention;

FIG. 4 is a perspective view of a sheet material cutter device mounted on a general purpose container illustrating one embodiment of the present invention; and

FIG. 5 is a cross-section view of a tooth of the cutting edge of the sheet metal cutter device illustrating one embodiment of the present invention.

### DETAILED DESCRIPTION OF THE INVENTION

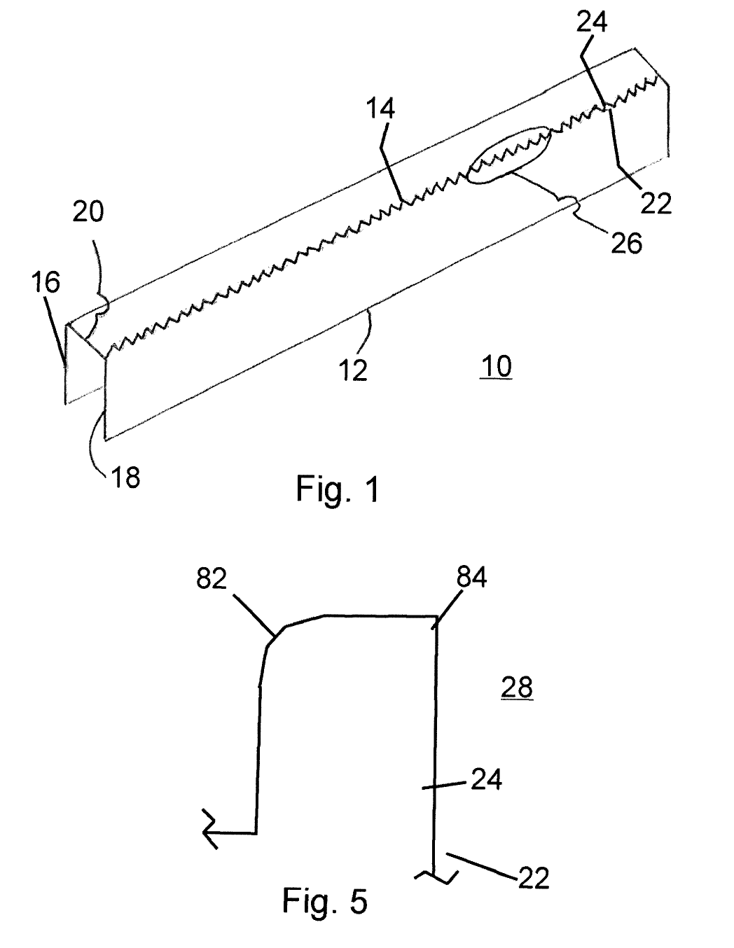

FIG. 1 illustrates a device 10 for cutting food wrap or other sheet material 60 according to one embodiment of the present invention. The device 10 has a mounting portion 12 and a cutting portion 14. These portions 12, 14 can be separate pieces or can be formed as part of a unitary piece, for example by injection molding. The portions 12, 14 in this embodiment are formed from hard plastic, but the portions can be any material or combination of materials such as, for example, metal, plastic, rubber, or wood.

The mounting portion 12 in this embodiment is a channel defined by two side arms or plates 16, 18 and a base or top plate 20 defining a rectangular cross-section. However, the mounting portion 12 can have other shapes, for example a square, curved or circular cross section. Also, other shapes for the mounting portion 12 such as spherical, oblong, or free form are also possible.

In this embodiment, the length of the device 10, that is along the direction of the cutting edge 14, is 13 inches (33.0 centimeters), the inside width, that is across the base 20 is 12/16 inches (1.9 centimeters), the inside depth across the first arm 16 is 14/16 inches (2.2 centimeters) and the inside depth across the second arm is 15/16 inches (2.4 centimeters). The plates 16, 18, and 20 in this embodiment are each ⅛ inches (0.3 centimeters) thick.

This embodiment employs dimensions for a typical kitchen drawer and a typicial food wrap roll, but any dimensions which allow for the removable attachment of the device 10 to the wall 42 of a general purpose storage container 40 can be used. Also, the height of the cutting portion 14 is selected to allow enough clearance for a typical drawer to be moved normally from open to closed positions with respect to a cabinet. Also, if the dimensions of the channel are too large for a particular container, shims can be used between the arms 16, 18 and the respective wall 42 surface to keep the device 10 in place.

The cutting portion 14 in this embodiment has a first side 22 which connects to the mounting portion 12 and a second side 24 which extends away from the mounting portion 12. This second side 24 is configured with a cutting edge 26. The cutting edge 26 in this embodiment is serrated, that is formed as a plurality of cutting teeth 28 and are configured to easily guide and tear off selected portions of the sheet material. In this embodiment, each tooth is 3/16 inches (0.5 centimeters) in height and the cutting portion is ⅛ inches (0.3 centimeters) thick.

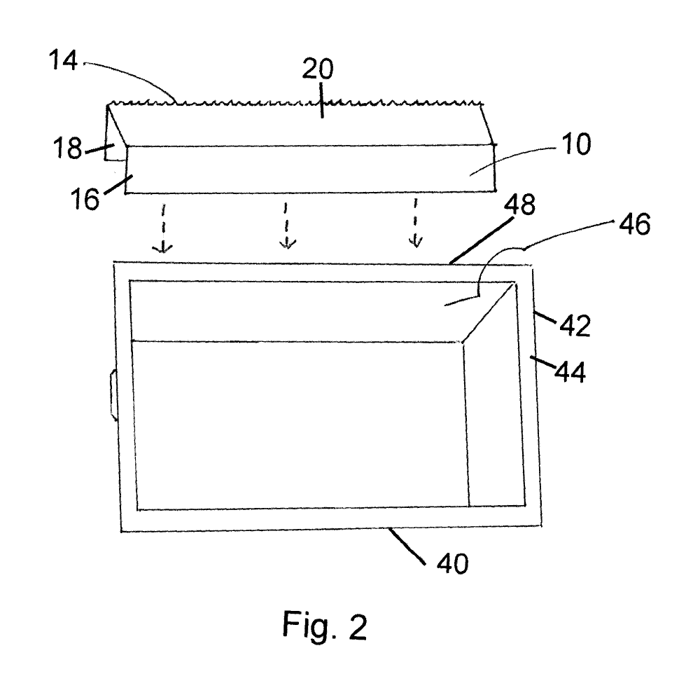

FIG. 2 illustrates the attachment or mounting of the device 10 to a general purpose storage container 40. In this embodiment, the general purpose storage container 40 is a drawer, but other storage containers, such as for example as wooden box, a storage chest or tool box could be used. The container 40 of FIG. 2 has a wall 42 which includes four upright side panels. In this embodiment, the mounting portion 12 of the device 10 is attached to one of the side panels of the wall 42 by placing the channel over the top 44 of the wall such that the base 20 abuts or aligns with the top of the wall 42 such that the first arm 16 abuts or aligns with the inside surface 46 of the wall 42 and the second arm 18 abuts or aligns with the outside surface 48 of the wall 42.

In this embodiment, the cutting portion 14 is attached to the mounting portion 12 such that the cutting edge 26 extends above and aligns with the outside surface 48 of the wall 42. By aligning with the outside surface 48 of the wall 42, after a selected piece 62 of the sheet material 60 is torn away, the remaining edge of the sheet material remains frictionally connected to the cutting edge 26 along the tear and a portion of the remaining sheet material is also frictionally connected to the inside edge 66 between the base 20 and the first arm 16. By having these two frictional connections, the remaining sheet material 60 is held from falling back into drawer 40. In this way, the sheet material 60 can be conveniently grasped from above the wall 42 for selecting another piece of sheet material to sever without having to reach into the drawer 40. By maximizing the distance between the cutting edge 26 and the inside edge 66, the angle of the frictionally attached sheet material is lower, and the sheet material is more likely to remain frictionally attached to the device 10 for subsequent use.

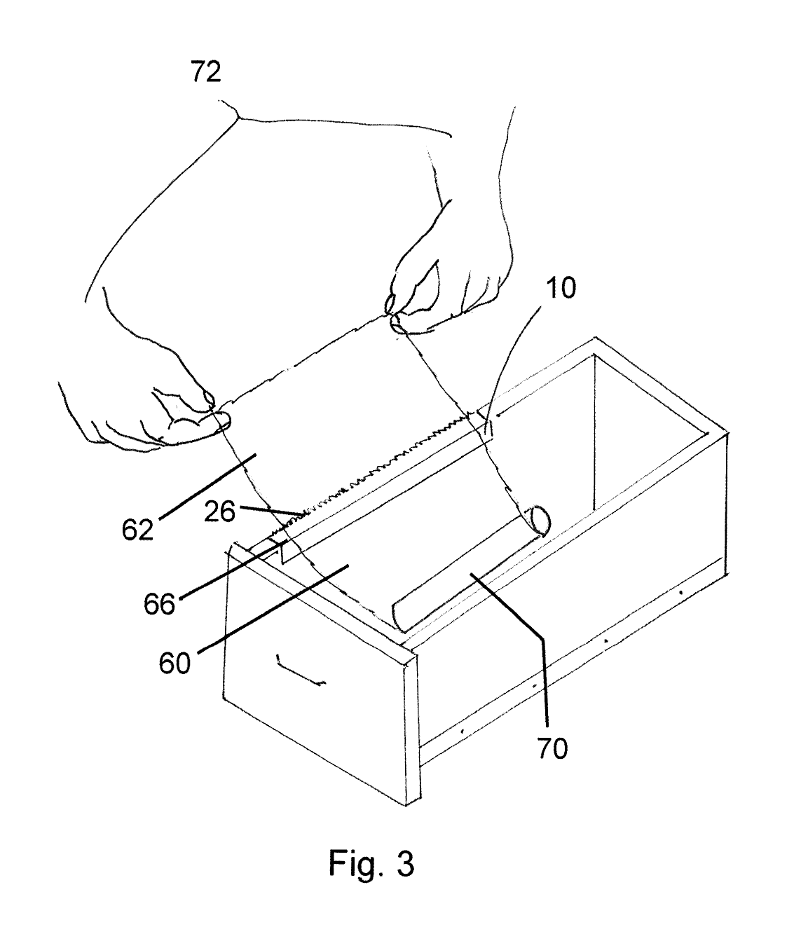

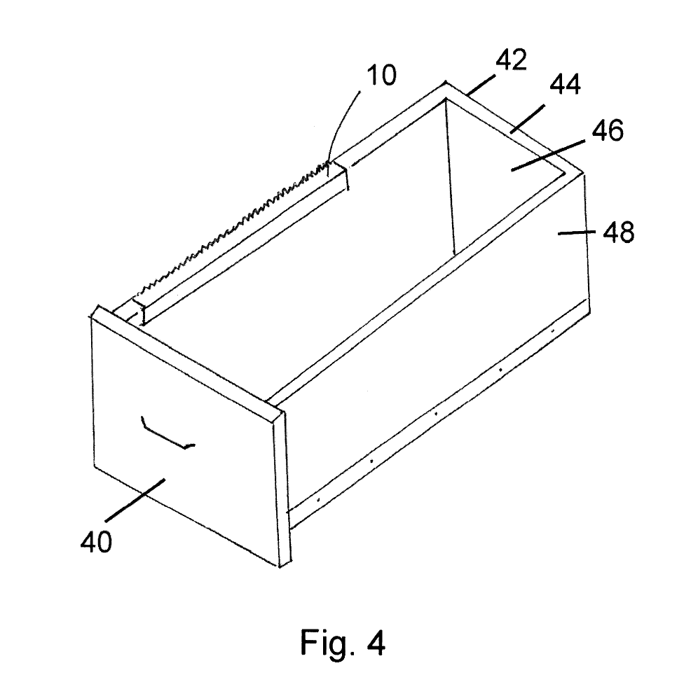

FIG. 3 illustrates the pulling of the sheet material 60 from a supply roll 70 resting on the bottom the general purpose storage container 40. The supply roll 70 could also be in a specialty container for the sheet material 60 with the top cover opened or removed. In operation, a user pulls the sheet material 60 from the supply roll 70 over the top of the device 10 first passing over the inside edge 66 and then over the cutting edge 26 for tearing off a selected piece of the sheet material. This operation may be performed using one or two hands 72, thereby, easily guiding and tearing off the selected portion of the sheet material 60. FIG. 4 illustrates the device 10 mounted on a wall 42 of a general purpose storage device 40 before the sheet material 60 is pulled.

FIG. 5 illustrates the shape of one of the teeth 28 of a cutting edge 26 of the device 10 according to one embodiment of the invention. In this embodiment, the tooth 28 has a rounded edge 82 on the inside facing side of the cutting edge 26 to reduce the possibility of injury to a user's hand if the user's hand is accidently moved along the cutting edge 26.

Among the distinguishable features of the present invention is an inside drawer mounted apparatus having one or more pieces which are removable, dimensions for attachment to a wide, that is greater than ⅛ inch (0.3 centimeters) wall, and/or the ability to be concealed when the drawer is in the closed position.

While the device may be used in any application involving sheet materials, in one embodiment the sheet material 60 is food wrap, such as for example, plastic wrap, waxed paper, aluminum foil wrap, freezer paper, and parchment paper. These sheet material examples are not intended to limit the scope of the invention.

The present invention has been described by way of exemplary embodiments to which it is not limited. Variations and modifications will occur to those skilled in the art without departing from the scope of the present invention as recited in the appended claims and equivalents thereof.

What is claimed is:

1. A device for cutting sheet material comprising:
a mounting portion for attachment to a wall of a general purpose storage container, the general purpose storage container having a holder for the sheet material, and storage space for objects other than the sheet material; and
a cutting portion attached to the mounting portion along a first side and having a cutting edge along a second side.

2. The device of claim 1 wherein the general purpose storage container is a drawer.

3. The device of claim 2 wherein drawer is mounted in a cabinet.

4. The device of claim 3 wherein the drawer further comprises:
means for moving the drawer from a first position where at least a portion of the cutting portion is accessible from outside the cabinet and a second position where the cutting portion is not accessible from outside the cabinet.

5. The device of claim 1 wherein the holder is a bottom surface of the general purpose storage container.

6. The device of claim 1 wherein the mounting portion is removably attached to the wall.

7. The device of claim 1 wherein the mounting portion comprises a channel having a base and two arms, the channel being placed over a top of the wall such that the base of the channel is adjacent to the top of the wall and the arms of the channel are adjacent to the inside surface and outside surface of the wall respectively.

8. The device of claim 7 wherein the base and arms of the channel are generally flat.

9. The device of claim 1 wherein the second side of the cutting portion is positioned parallel to, and proximate to, the plane defined by the outside surface of the wall.

10. The device of claim 1 wherein the cutting edge comprises:
a series of teeth for cutting the sheet material.

11. The device of claim 9 wherein a corner between a ridge of the tooth and the inside wall of the tooth is rounded.

12. The device of claim 9 wherein a corner between a ridge of the tooth and the outside wall of the tooth forms and angle of about 90 degrees.

13. A system for cutting sheet material comprising:
a drawer having general storage space for holding a sheet material supply and at least one other object; and
a cutter having a mounting portion and a cutting portion, the mounting portion providing means for attaching the cutter to a wall of the drawer.

14. A method for cutting sheet material comprising the steps of:
opening a drawer having a cutter on a wall of the drawer;
pulling sheet material from a holder in the drawer such that the sheet material extends across a cutting edge of the cutter;
applying stress to the sheet material, such that a portion of the sheet material presses against the cutting edge of the cutter;
severing a portion of the sheet material from the sheet material along the portion of the sheet material pressing against the cutting edge;
removing the severed portion for use; and
closing the drawer.

15. The method of claim 14 further comprising the step of attaching a mounting portion of the cutter to the wall.

16. The method of claim 15 further comprising the step of detaching a mounting portion of the cutter from the wall to remove the cutter.
